(19) United States
(12) Patent Application Publication
(10) Pub. No.: US 2025/0381616 A1
(43) Pub. Date: Dec. 18, 2025

(54) LASER PROCESSING APPARATUS

(71) Applicant: Panasonic Intellectual Property Management Co., Ltd., Osaka (JP)

(72) Inventors: KOJI FUNAMI, Kyoto (JP); KAZUKI FUJIWARA, Osaka (JP); IZURU NAKAI, Osaka (JP); TATSURO SHIRAISHI, Osaka (JP)

(21) Appl. No.: 19/303,425

(22) Filed: Aug. 19, 2025

Related U.S. Application Data
(63) Continuation of application No. PCT/JP2024/006387, filed on Feb. 21, 2024.

(30) Foreign Application Priority Data
Mar. 15, 2023 (JP) 2023-041308

(51) Int. Cl. B23K 26/06; B23K 26/22; B23K 26/26; B23K 26/082

(52) U.S. Cl. CPC B23K 26/0643; B23K 26/22; B23K 26/26; B23K 26/082

(57) ABSTRACT

A laser processing apparatus according to the present disclosure includes: an oscillator that oscillates a laser beam; an irradiation optical system that guides the laser beam to a member to be processed; a measurement optical system that guides, from a measurement region, processing light including any one of thermal radiation light, plasma light, and reflected light emitted from the member by irradiation with the laser beam; a sensor that measures intensity of the processing light guided by the measurement optical system; a moving device that moves an irradiation spot by the laser beam relative to the member from a start point along a scanning path; an adjustment device that shifts a position of the measurement region with respect to a position of the irradiation spot; and a control unit that controls the adjustment device such that a center of the measurement region is located closer to a start point side than a center of the irradiation spot along the scanning path.

### TECHNICAL FIELD

The present disclosure relates to a laser processing apparatus.

### BACKGROUND ART

Examples of a laser processing apparatus include an apparatus that evaluates a processing state in addition to processing of a member. When the member is irradiated with a laser beam, the member is melted to form a melted portion. Light including thermal radiation light, plasma light, laser reflected light, and the like is emitted from the melted portion. The processing state can be evaluated by measuring the peak intensity of the light and the integral value (emission energy) of the light intensity.

For example, in PTL 1, a laser beam is emitted from a head, light emitted from a melted portion is measured using a measurement unit attached to the head, and a processing state is monitored.

In addition, in PTL 2, a laser beam is emitted from a head, light emitted from a melted portion is guided to one end of an optical fiber attached to the head, and a processing state is monitored using a measurement unit attached to the other end of the optical fiber.

### Citation List

### Patent Literature

PTL 1: WO 2018/185973

PTL 2: Unexamined Japanese Patent Publication No. 3184969

### SUMMARY OF THE INVENTION

In the laser processing apparatuses described in PTL 1 and PTL 2, light emitted from a melted portion is measured from a measurement region around an irradiation position of a laser beam. In a case where spot irradiation of irradiating one point with a laser beam is performed, the melted portion is formed around the irradiation position of the laser beam. On the other hand, in a case where the laser beam is irradiated while being scanned, the melted portion is maintained in a melted state even after the laser beam is separated, so that the melted portion extends from the irradiation position in the direction opposite to the scanning direction. For this reason, it is difficult to measure the light emitted from the melted portion which is partially deviated from the measurement region around the irradiation position. Therefore, the evaluation accuracy of the processing state may be deteriorated.

Therefore, an object of the present disclosure is to solve the above-described conventional problem, and to improve evaluation accuracy of a processing state in laser processing.

A laser processing apparatus according to one aspect of the present disclosure includes: an oscillator that oscillates a laser beam; an irradiation optical system that guides the laser beam to a member to be processed; a measurement optical system that guides, from a measurement region, processing light including any one of thermal radiation light, plasma light, and reflected light emitted from the member by irradiation with the laser beam; a sensor that measures intensity of the processing light guided by the measurement optical system; a moving device that moves an irradiation spot by the laser beam relative to the member from a start point along a scanning path; an adjustment device that shifts a position of the measurement region with respect to a position of the irradiation spot; and a control unit that controls the adjustment device such that a center of the measurement region is located closer to a start point side than a center of the irradiation spot along the scanning path.

According to the laser processing method according to the present disclosure, it is possible to improve the evaluation accuracy of the processing state in the laser processing.

### BRIEF DESCRIPTION OF THE DRAWINGS

FIG. 1 is an overall view of a laser processing apparatus according to a first exemplary embodiment of the present invention.

FIG. 2 is a detailed view of a measurement unit.

FIG. 3 is a top view of a member in spot welding processing.

FIG. 4 is a top view of a member in line welding processing.

FIG. 5 is a view illustrating an irradiation spot and a measurement region.

FIG. 6A is a view illustrating a comparative example of a shift amount and a shift direction.

FIG. 6B is a view illustrating a comparative example of a shift amount and a shift direction.

FIG. 6C is a view illustrating a comparative example of a shift amount and a shift direction.

FIG. 6D is a view illustrating a comparative example of a shift amount and a shift direction.

FIG. 6E is a view illustrating a comparative example of a shift amount and a shift direction.

FIG. 7 is a graph of a shift amount and thermal radiation light intensity.

FIG. 8A is a top view of a member in line welding processing in a first mode.

FIG. 8B is a top view of a member in line welding processing in the first mode.

FIG. 8C is a top view of a member in line welding processing in the first mode.

FIG. 9 is a graph of elapsed time and thermal radiation light intensity.

FIG. 10A is a top view of a member in line welding processing in a second mode.

FIG. 10B is a top view of a member in line welding processing in the second mode.

FIG. 10C is a top view of a member in line welding processing in the second mode.

FIG. 11 is a graph of elapsed time and thermal radiation light intensity.

FIG. 12 is a schematic view of laser sealing welding of a square secondary battery.

FIG. 13 is a top view of an exterior case and a sealing plate.

FIG. 14A is a view illustrating a change in an X coordinate of an irradiation spot in a scanning path.

FIG. 14B is a view illustrating a change in a Y coordinate of an irradiation spot in a scanning path.

FIG. 15A is a view illustrating a scanning speed of an irradiation spot in an X direction.

FIG. 15B is a view illustrating a scanning speed of an irradiation spot in a Y direction.

FIG. 16A is a view illustrating a shift amount in an X direction.

FIG. 16B is a view illustrating a shift amount in a Y direction.

FIG. 17A is a view illustrating a welding state on a first side.

FIG. 17B is a view illustrating a welding state on a second side.

FIG. 17C is a view illustrating a welding state on a third side.

FIG. 17D is a view illustrating a welding state on a fourth side.

FIG. 18 is a top view of laser welding of an electrode terminal of a cylindrical secondary battery.

FIG. 19 is a cross-sectional view of laser welding of the electrode terminal of the cylindrical secondary battery.

FIG. 20 is a view illustrating a welding state.

FIG. 21 is an overall view of a laser processing apparatus in a first modification.

### DESCRIPTION OF EMBODIMENT

Hereinafter, an exemplary embodiment of the present disclosure will be described in detail with reference to the drawings. Note that, the present disclosure is not limited to the following exemplary embodiment. Modifications can be made as appropriate without departing from the scope within which an effect of the present disclosure is exhibited. Combinations with other exemplary embodiments are also possible.

### First exemplary embodiment

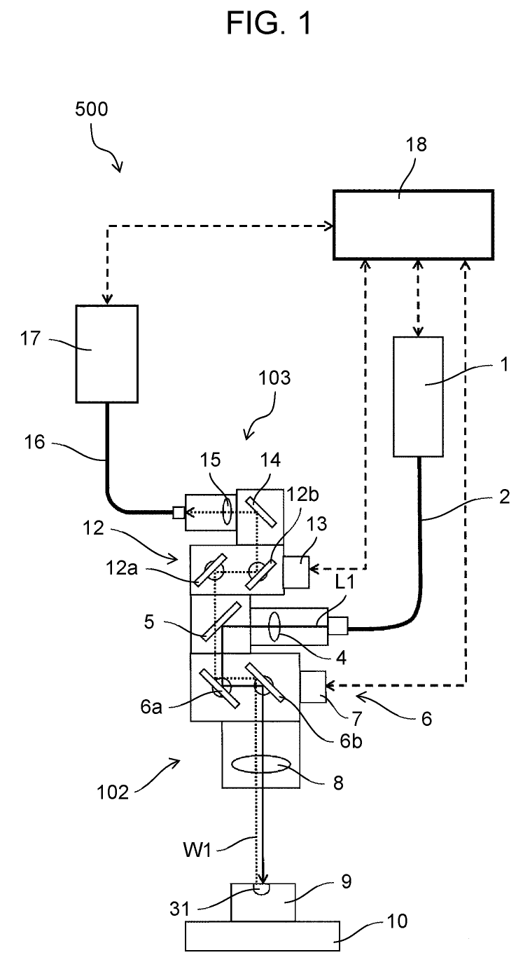

FIG. 1 is an overall view of laser processing apparatus 500 according to a first exemplary embodiment of the present disclosure. As illustrated in FIG. 1, laser processing apparatus 500 is an apparatus that irradiates laser beam L1 and processes member 9 to be processed by irradiation with laser beam L1. Laser processing apparatus 500 includes oscillator 1, optical fiber 2, positioning jig 10, irradiation optical system 102, moving device 6, measurement optical system 103, adjustment device 12, measurement unit 17, and control unit 18.

Oscillator 1 is a device that oscillates laser beam L1. Oscillator 1 oscillates, for example, laser beam L1 having a wavelength of 1070 nm.

Optical fiber 2 connects oscillator 1 and irradiation optical system 102. Laser beam L1 is guided from oscillator 1 to irradiation optical system 102 by optical fiber 2.

Positioning jig 10 is a jig for positioning member 9 with respect to irradiation optical system 102.

Irradiation optical system 102 guides laser beam L1 to the surface of member 9 to be processed. Irradiation optical system 102 irradiates the surface of member 9 with laser beam L1 in a range of an irradiation spot (irradiation spot 30 in FIG. 3 to be described later). Irradiation optical system 102 includes a plurality of optical elements, and includes, for example, collimator lens 4, dichroic mirror 5, and condenser lens 8.

Moving device 6 moves the irradiation spot of laser beam L1 relative to member 9. Moving device 6 includes, for example, movable first mirror 6a, movable second mirror 6b, and first mirror control unit 7. In the first exemplary embodiment, mirrors 6a, 6b are disposed between dichroic mirror 5 and condenser lens 8 coaxially with irradiation optical system 102, and reflect laser beam L1. First mirror control unit 7 includes a controller that controls the postures of mirrors 6a, 6b with respect to the optical axis of irradiation optical system 102. Specifically, first mirror control unit 7 controls the angles of mirrors 6a, 6b. First mirror control unit 7 controls the reflection direction of laser beam L1 and two-dimensionally controls the position of the irradiation spot with respect to member 9. For example, assuming that the surface of member 9 is an XY plane, first mirror control unit 7 controls the X position of the irradiation spot by controlling the angle of first mirror 6a, and controls the Y position of the irradiation spot by controlling the angle of second mirror 6b. In addition, first mirror control unit 7 controls the scanning speed of the irradiation spot by controlling the change rate (rotation speed) of the angles of mirrors 6a, 6b, and controls the scanning direction of the irradiation spot by controlling the rotation direction of the angles of mirrors 6a, 6b. Moving device 6 may be referred to as a galvano system.

In irradiation optical system 102, laser beam L1 becomes a parallel beam by collimator lens 4 and is bent at a right angle by dichroic mirror 5. In dichroic mirror 5, the surface is coated, and only the wavelength (for example, 1070 nm) of laser beam L1 is totally reflected, and the other wavelengths are transmitted. However, in the present specification, “total reflection” means reflection of 99% or more, and the remainder of about 1% of laser beam L1 passes through dichroic mirror 5. Laser beam L1 reflected from dichroic mirror 5 is reflected by mirrors 6a, 6b, condensed on the irradiation spot by condenser lens 8, and applied to the surface of member 9.

When member 9 is irradiated with laser beam L1, member 9 is heated and melted to form melted portion 31. Welding light W1 is emitted from melted portion 31. Welding light W1 includes any one of plasma light that is visible light, thermal radiation light highly correlated with the temperature of member 9, reflected light of laser beam L1, and the like. Welding light W1 emitted from member 9 is guided to measurement unit 17 via measurement optical system 103.

Measurement optical system 103 guides welding light W1 from a measurement region (measurement region 33 in FIG. 3 to be described later) on the surface of member 9 to measurement unit 17. Measurement optical system 103 includes a plurality of optical elements, and includes, for example, condenser lens 8, dichroic mirror 5, total reflection mirror 14, imaging lens 15, and optical fiber 16. In the first exemplary embodiment, condenser lens 8 and dichroic mirror 5 are common to measurement optical system 103 and irradiation optical system 102.

Furthermore, welding light W1 is reflected by mirrors 6a, 6b of moving device 6 disposed between condenser lens 8 and dichroic mirror 5. Therefore, moving device 6 relatively moves the measurement region of welding light W1 with respect to member 9 together with the irradiation spot. The scanning speed and the scanning direction of the measurement region can be made common to the scanning speed and the scanning direction of the irradiation spot.

Adjustment device 12 shifts the position of the measurement region with respect to the position of the irradiation spot of laser beam L1. Adjustment device 12 includes movable third mirror 12a, movable fourth mirror 12b, and second mirror control unit 13. By having mirrors 12a, 12b independent from moving device 6, adjustment device 12 can adjust the position of the measurement region with respect to the position of the irradiation spot. That is, the position of the measurement region with respect to member 9 is determined by the operations of both moving device 6 and adjustment device 12. In the first exemplary embodiment, mirrors 12a, 12b are disposed coaxially with measurement optical system 103 between dichroic mirror 5 and total reflection mirror 14, and reflect welding light W1. Second mirror control unit 13 includes a controller that controls the postures of mirrors 12a, 12b with respect to the optical axis of measurement optical system 103. Specifically, second mirror control unit 13 controls the angles of mirrors 12a, 12b. Second mirror control unit 13 controls the reflection direction of welding light W1, shifts welding light W1 from the same axis as laser beam L1, and controls the shift amount and the shift direction of the measurement region with respect to the irradiation spot.

For example, second mirror control unit 13 controls the shift amount of the measurement region in the X direction by controlling the angle of third mirror 12a, and controls the shift amount of the measurement region in the Y direction by controlling the angle of fourth mirror 12b. In addition, second mirror control unit 13 controls the shift direction by the rotation direction of mirrors 12a, 12b and a combination (combined vector) of the shift amounts in the X direction and the Y direction.

Welding light W1 generated in the measurement region passes through dichroic mirror 5 via condenser lens 8 and mirrors 6a, 6b, and is reflected by mirrors 12a, 12b. Welding light W1 reflected by mirrors 12a, 12b is bent at a right angle by total reflection mirror 14, and is imaged on the end surface of optical fiber 16 by imaging lens 15. Welding light W1 transmitted by optical fiber 16 is incident on measurement unit 17.

Measurement unit 17 measures the intensity of welding light W1 guided by measurement optical system 103, and transmits an electric signal corresponding to the intensity to control unit 18.

Control unit 18 is a controller that controls entire laser processing apparatus 500. Control unit 18 includes a general-purpose processor such as a CPU or an MPU that implements a predetermined function by executing a program. Control unit 18 achieves various controls in laser processing apparatus 500 by calling up and executing a control program stored in a memory (not illustrated). Control unit 18 is not limited to one that implements a predetermined function through cooperation of hardware and software, but control unit 18 may be a hardware circuit designed exclusively for implementing a predetermined function. In other words, control unit 18 can be achieved by various processors such as a CPU, an MPU, a GPU, an FPGA, a DSP, and an ASIC. Control unit 18 implements, for example, synchronization control of oscillator 1, first mirror control unit 7, and second mirror control unit 13. In addition, control unit 18 performs arithmetic processing on the electrical signal transmitted from measurement unit 17 and evaluates the processing state of member 9.

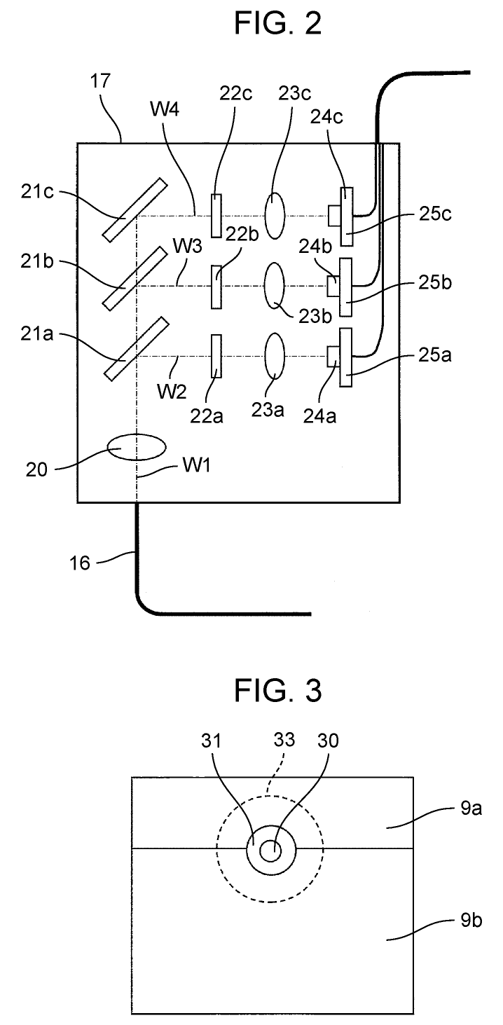

Next, measurement unit 17 will be described with reference to FIG. 2. FIG. 2 is a detailed view of measurement unit 17.

As illustrated in FIG. 2, measurement unit 17 includes a plurality of optical elements and sensors. Measurement unit 17 has, for example, collimating lens 20, reflection mirrors 21a, 21b, and 21c, filters 22a, 22b, and 22c, imaging lenses 23a, 23b, and 23c, light receiving sensors 24a, 24b, and 24c, and amplifiers 25a, 25b, and 25c.

Welding light W1 guided by optical fiber 16 is converted into a parallel light by collimating lens 20, and then separated for each wavelength by the plurality of reflection mirrors 21a, 21b, and 21c. In the first exemplary embodiment, reflection mirrors 21a, 21b, and 21c separate welding light W1 into three kinds of wavelengths. Specifically, from welding light W1, reflection mirror 21a separates plasma light W2 (wavelength of 400 nm to 700 nm), reflection mirror 21b separates laser reflected light W3 (wavelength of 1070 nm), and reflection mirror 21c separates thermal radiation light W4 (wavelength of 1300 nm). Each of reflection mirrors 21a, 21b, and 21c has a front surface coated so as to reflect only the wavelength to be separated and transmit the other wavelengths.

Welding light W2, W3, and W4 reflected by reflection mirrors 21a, 21b, and 21c pass through corresponding filters 22a, 22b, and 22c, respectively. Welding light W2, W3, and W4 having passed are incident on corresponding light receiving sensors 24a, 24b, and 24c by corresponding imaging lenses 23a, 23b, and 23c, respectively. Light receiving sensors 24a, 24b, 24c measure intensity of welding light W2, W3, W4. The intensity measured by light receiving sensors 24a, 24b, and 24c is converted into electric signals by corresponding amplifiers 25a, 25b, and 25c, and transmitted to control unit 18.

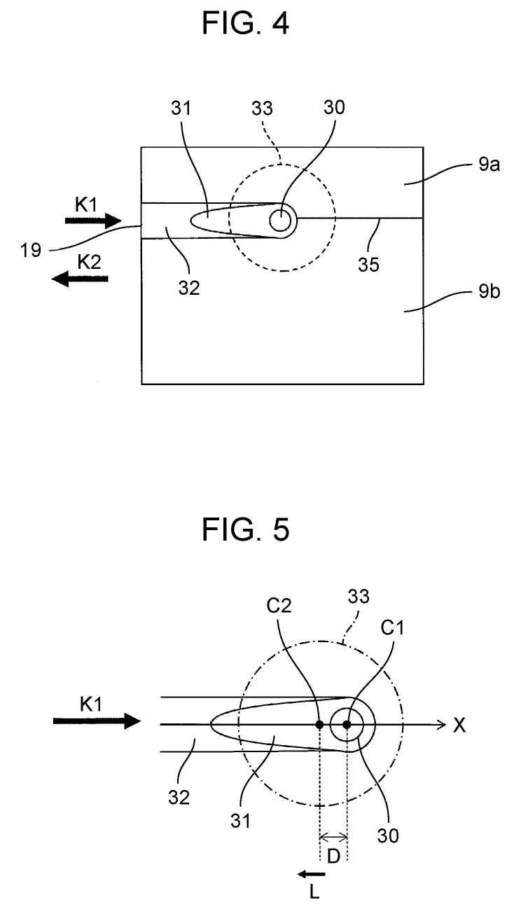

Here, the melted portion generated by irradiation will be described in more detail with reference to FIGS. 3 and 4. An example in which two members 9a, 9b are joined as member 9 to be processed will be described. FIG. 3 is a top view of members 9a, 9b in spot welding processing. FIG. 4 is a top view of members 9a, 9b in line welding processing. In FIGS. 3 and 4, two members 9a, 9b are joined by welding.

As illustrated in FIG. 3, in spot welding, one point of the boundary between members 9a, 9b is irradiated with laser beam L1. That is, irradiation spot 30 of laser beam L1 is stationary with respect to members 9a, 9b. In the first exemplary embodiment, irradiation spot 30 is circular, but is not limited thereto. Irradiated members 9a, 9b are heated and melted to form melted portion 31 around irradiation spot 30. Melted portion 31 is larger than irradiation spot 30 and includes irradiation spot 30 and members 9a, 9b around irradiation spot 30. Since irradiation spot 30 is circular, melted portion 31 is a circular shape concentric with irradiation spot 30. When the irradiation with laser beam L1 is completed, melted portion 31 is solidified, and members 9a, 9b are joined.

In this case, welding light W1 emitted from melted portion 31 can be measured by providing measurement region 33 including melted portion 31 concentrically with irradiation spot 30.

As illustrated in FIG. 4, in the line welding, laser beam L1 is scanned along the boundary between members 9a, 9b. In other words, the boundary between members 9a, 9b define scanning path 35 of irradiation spot 30. Moving device 6 scans irradiation spot 30 along scanning path 35 in scanning direction K1 from start point 19 on the left side.

Melted portion 31 is formed by irradiation with laser beam L1 similarly to spot welding. Melted members 9a, 9b do not solidify immediately even after irradiation spot 30 passes, and maintain a melted state for a certain period of time. Therefore, melted portion 31 has an elongated shape extending in direction K2 opposite to scanning direction K1 toward the side where irradiation spot 30 has already passed, that is, toward start point 19. In addition, the power of laser beam L1 increases toward the center of irradiation spot 30, and thus the time during which the melted state is maintained increases from the edge of irradiation spot 30 toward the center of irradiation spot 30. Therefore, melted portion 31 has a tapered shape toward start point 19. The shape of melted portion 31 varies depending on the scanning speed at which irradiation spot 30 moves, the power of laser beam L1, the absorptivity and thermal conductivity of members 9a, 9b, and the like. When melted portion 31 is solidified, solidified portion 32 is formed, and members 9a, 9b are joined.

If measurement region 33 is provided concentrically with irradiation spot 30 with respect to elongated melted portion 31, melted portion 31 on a start point 19 side deviates from measurement region 33, and it becomes difficult to measure welding light W1 emitted from melted portion 31. In addition, measurement region 33 is enlarged such that melted portion 31 on the start point 19 side is included, but in this case, melted portion 31 becomes relatively small, the strength of welding light W1 decreases, and the SN ratio (signal-to-noise ratio) deteriorates. Therefore, the measurement accuracy of welding light W1 is deteriorated.

Therefore, in order to measure welding light W1 emitted from elongated melted portion 31, measurement region 33 is provided at a position shifted with respect to irradiation spot 30. Specifically, control unit 18 causes adjustment device 12 to shift the center of measurement region 33 so as to be positioned closer to the start point 19 side than the center of irradiation spot 30 along scanning path 35.

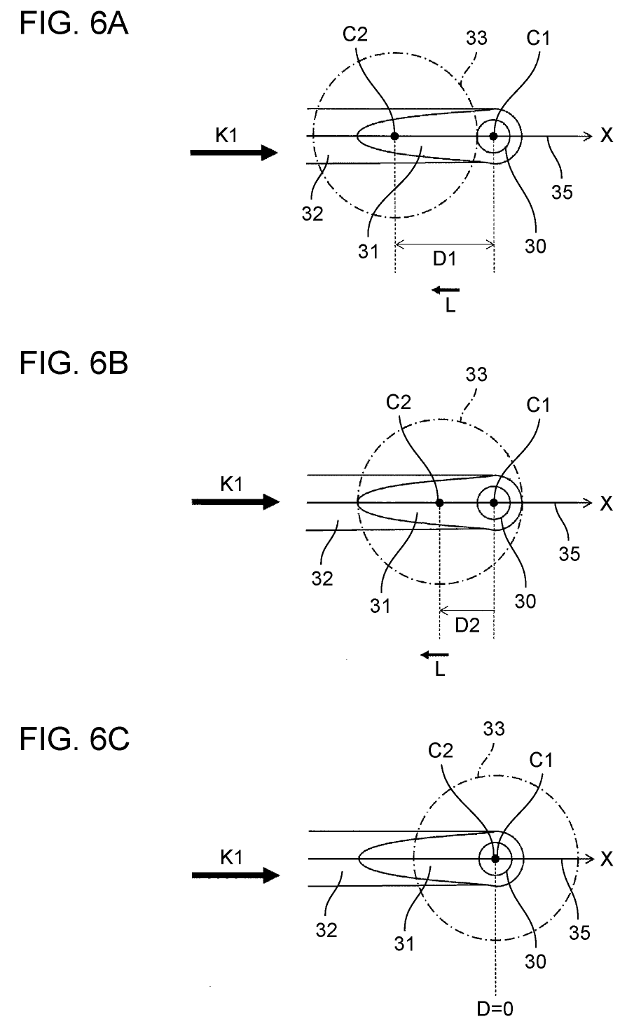

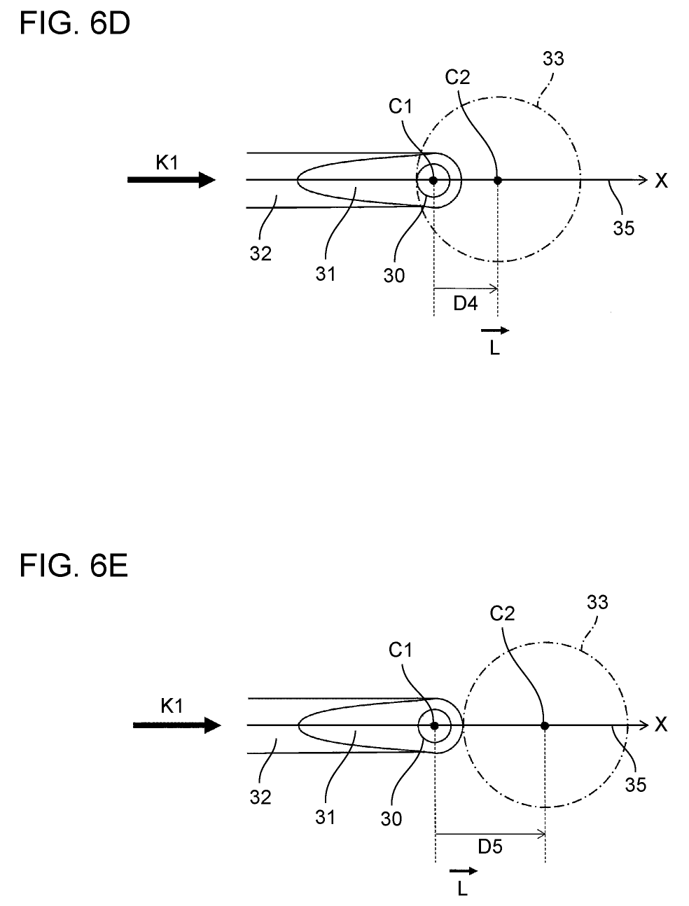

Shift amount D and shift direction L of center C2 of measurement region 33 with respect to center C1 of irradiation spot 30 will be described in more detail. FIG. 5 is a view illustrating irradiation spot 30 and measurement region 33. FIGS. 6A to 6E are views illustrating comparative examples of different shift amounts D and shift directions L.

As illustrated in FIG. 5, the position of center C1 of irradiation spot 30 is set as a reference (X = 0) with the X axis in the same direction as scanning direction K1. In the present specification, the “center” is a midpoint of a long axis taken in scanning direction K1 in a certain region. Shift amount D is a distance obtained by shifting center C2 of measurement region 33 with respect to center C1 of irradiation spot 30, and is a size of an interval between centers C1, C2. Shift direction L is a direction in which center C2 of measurement region 33 is shifted with respect to center C1 of irradiation spot 30, and is the +X direction or the -X direction in the following.

FIG. 6A illustrates a state in which center C2 of measurement region 33 is moved in the -X direction (toward start point 19 in FIG. 4) by shift amount D1 so that measurement region 33 is out of irradiation spot 30. FIG. 6B illustrates a state in which center C2 of measurement region 33 is moved in the -X direction (toward start point 19 in FIG. 4) by shift amount D2 so that entire melted portion 31 is included in measurement region 33. FIG. 6C illustrates a state in which center C2 of measurement region 33 coincides with center C1 of irradiation spot 30 (a state of shift amount D = 0). FIG. 6D illustrates a state in which center C2 of measurement region 33 is moved in the +X direction by shift amount D4 so that entire irradiation spot 30 is just included in measurement region 33. FIG. 6E illustrates a state in which center C2 of measurement region 33 is moved in the +X direction by shift amount D5 such that entire melted portion 31 is out of measurement region 33.

In the case of FIGS. 6A to 6E, adjustment device 12 shifts measurement region 33 with respect to irradiation spot 30 by shift amount D and shift direction L. Moving device 6 moves irradiation spot 30 and measurement region 33 in scanning direction K1 along scanning path 35. Therefore, measurement region 33 follows irradiation spot 30 with an interval of shift amount D from irradiation spot 30 in shift direction L.

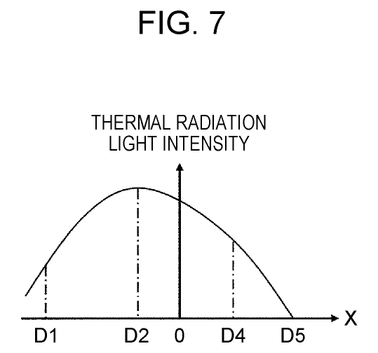

FIG. 7 is a graph of shift amount D and the intensity of the thermal radiation light measured from shifted measurement region 33. As illustrated in FIG. 7, the intensity of the thermal radiation light (that is, welding light W1) measured by measurement unit 17 is maximized in shift amount D2 in the -X direction. Since entire melted portion 31 is included in measurement region 33 shifted by shift amount D2, light receiving sensors 24a to 24c can receive welding light W1 from entire melted portion 31. Therefore, the processing state in entire melted portion 31 can be evaluated, and the evaluation accuracy of the processing state is improved.

In the first exemplary embodiment, measurement region 33 is shifted by shift amount D2 that maximizes the intensity of welding light W1 measured by measurement unit 17 and shift direction L opposite to scanning direction K1. Note that, another shift amount D may be applied in the direction opposite to scanning direction K1 of irradiation spot 30. Even with such a configuration, welding light W1 generated from melted portion 31 closer to the start point 19 side than irradiation spot 30 can be measured.

### Operation

Here, an example of the operation of laser processing apparatus 500 will be described. Control unit 18 executes so as to be switchable between the first mode and the second mode as the operation of laser processing apparatus 500. In the first mode, control unit 18 controls adjustment device 12 so that center C2 of measurement region 33 coincides with center C1 of irradiation spot 30. In the second mode, control unit 18 controls adjustment device 12 so that center C2 of measurement region 33 is located closer to the start point 19 side than center C1 of irradiation spot 30.

### First mode

The first mode is executed, for example, during spot welding. In the first mode, control unit 18 causes oscillator 1 to oscillate laser beam L1. Control unit 18 irradiates member 9 with laser beam L1 by irradiation optical system 102 and moving device 6. Specifically, control unit 18 controls the angles of mirrors 6a, 6b by first mirror control unit 7 to irradiate a predetermined position on member 9 with irradiation spot 30.

Subsequently, control unit 18 causes measurement optical system 103 to guide welding light W1 emitted from member 9 by irradiation to measurement unit 17. At this time, control unit 18 controls adjustment device 12 such that mirrors 12a, 12b have a reference angle. The reference angle is an angle at which welding light W1 incident on mirrors 12a, 12b is coaxial with laser beam L1. With such an operation, welding light W1 coaxial with laser beam L1 is guided to total reflection mirror 14, and center C2 of measurement region 33 and center C1 of irradiation spot 30 coincide with each other. Measurement unit 17 measures the intensity of welding light W1. Based on the measured intensity of welding light W1, control unit 18 evaluates the processing state of member 9.

### Second mode

The second mode is executed, for example, when processing is performed by scanning laser beam L1, such as line welding. In the following, straight line welding at a constant speed is considered. First, control unit 18 causes oscillator 1 to oscillate laser beam L1 to irradiate member 9. When laser beam L1 is emitted, control unit 18 controls the angles of mirrors 6a, 6b by first mirror control unit 7 to emit laser beam L1 while scanning irradiation spot 30 along scanning path 35. Specifically, first mirror control unit 7 controls the position of irradiation spot 30 according to the angles of mirrors 6a, 6b, controls the scanning direction according to the rotation direction of mirrors 6a, 6b, and controls the scanning speed of irradiation spot 30 according to the change rate of the angles of mirrors 6a, 6b.

Subsequently, control unit 18 determines shift amount D between center C2 of measurement region 33 and center C1 of irradiation spot 30 such that the intensity of welding light W1 measured by light receiving sensors 24a to 24c is maximized. Specifically, control unit 18 determines shift amount D based on the scanning speed of irradiation spot 30 such that the measured intensity of welding light W1 is maximized.

An example of the determination operation of shift amount D will be described, but the present invention is not limited thereto. For example, control unit 18 acquires a change rate (that is, the scanning speed of irradiation spot 30) of the angles of mirrors 6a, 6b. The memory of control unit 18 stores the maximum intensity position at which welding light W1 is maximized corresponding to the scanning speed of each irradiation spot 30. Control unit 18 refers to the memory to acquire the maximum intensity position corresponding to the applied scanning speed, and determines the distance from center C1 of irradiation spot 30 to the maximum intensity position as shift amount D.

Furthermore, control unit 18 may determine shift amount D based on the operation of oscillator 1 such as the power and wavelength of laser beam L1, or information input from the outside such as the material related to member 9.

Control unit 18 acquires a setting of adjustment device 12 for realizing determined shift amount D. For example, in the memory of control unit 18, the angles of mirrors 12a, 12b for realizing shift amount D are stored corresponding to each shift amount D. Control unit 18 refers to the memory to acquire the angles of mirrors 12a, 12b.

Subsequently, control unit 18 determines shift direction L of measurement region 33 based on scanning direction K1 of irradiation spot 30. Shift direction L is opposite to scanning direction K1.

Therefore, control unit 18 controls adjustment device 12 based on shift amount D and shift direction L. Specifically, control unit 18 controls the angles of mirrors 12a, 12b by second mirror control unit 13 to rotate mirrors 12a, 12b in a direction opposite to the rotation direction of mirrors 6a, 6b to an angle at which shift amount D is realized. In the case of line welding at a constant speed, control unit 18 performs processing while maintaining mirrors 12a, 12b in a rotated state.

Subsequently, control unit 18 causes measurement unit 17 to measure welding light W1 guided from shifted measurement region 33.

To summarize the above operations, control unit 18 determines shift amount D and shift direction L based on the scanning speed and scanning direction K1 of irradiation spot 30, and controls adjustment device 12 to shift measurement region 33. Considering that the operation of irradiation spot 30 is determined by the angles of mirrors 6a, 6b, and shift amount D and shift direction L are determined by mirrors 12a, 12b, control unit 18 controls the angles of mirrors 12a, 12b based on the angles of mirrors 6a, 6b.

By such an operation, center C2 of measurement region 33 is positioned closer to the start point 19 side along scanning path 35 than center C1 of irradiation spot 30, and measurement region 33 includes melted portion 31 on the start point 19 side. Therefore, welding light W1 generated closer to the start point 19 side than irradiation spot 30 is easily guided to measurement unit 17. Therefore, measurement unit 17 can monitor the processing state of entire melted portion 31, and the evaluation accuracy of the processing state is improved.

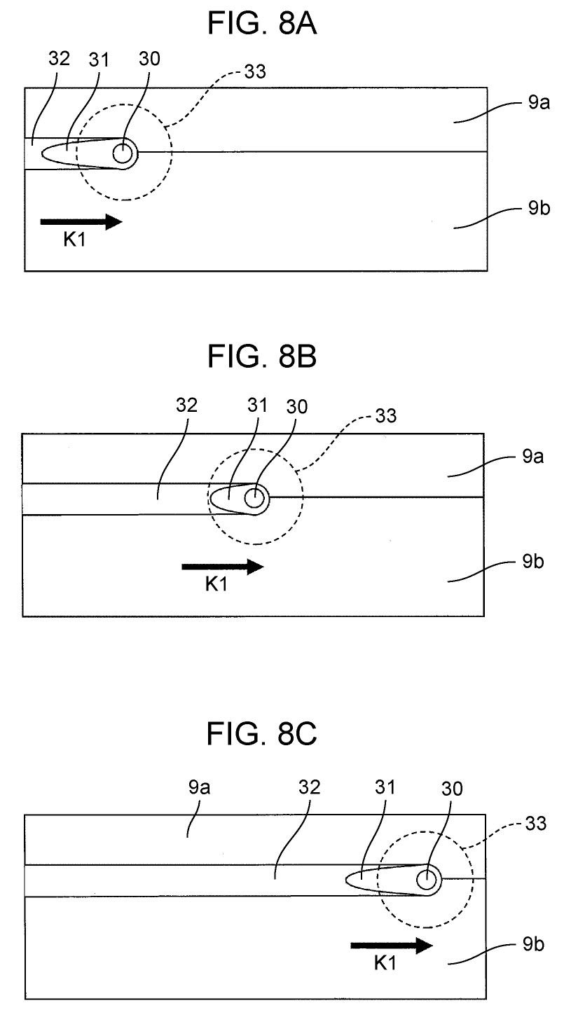

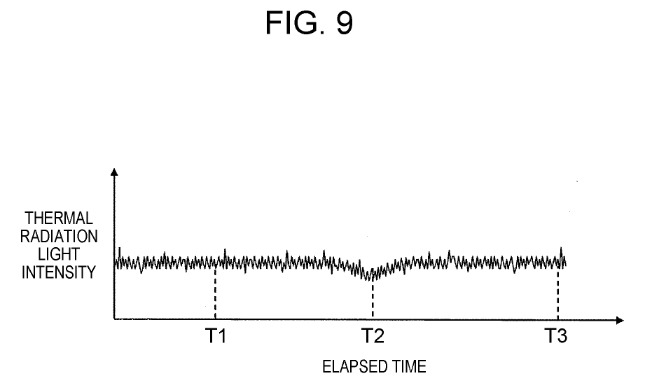

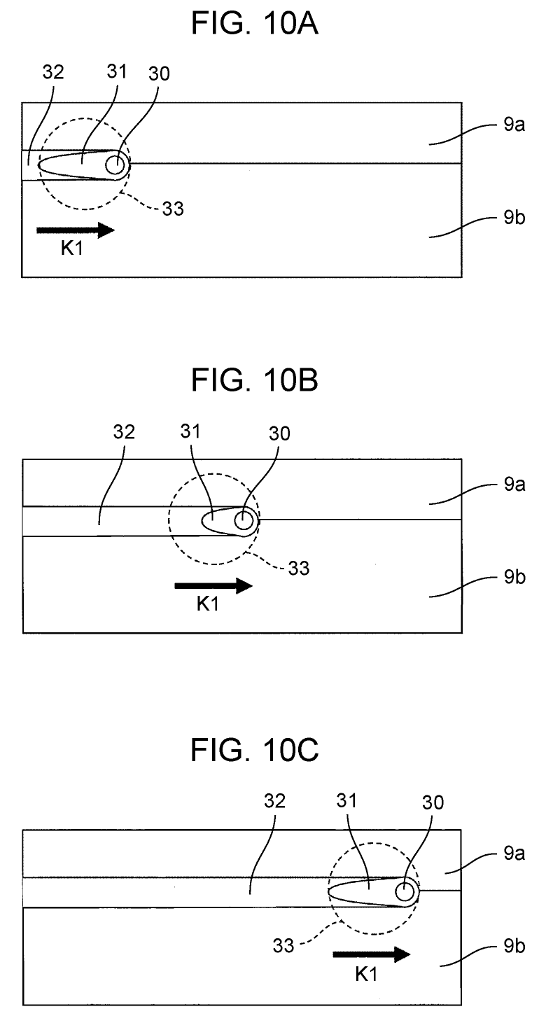

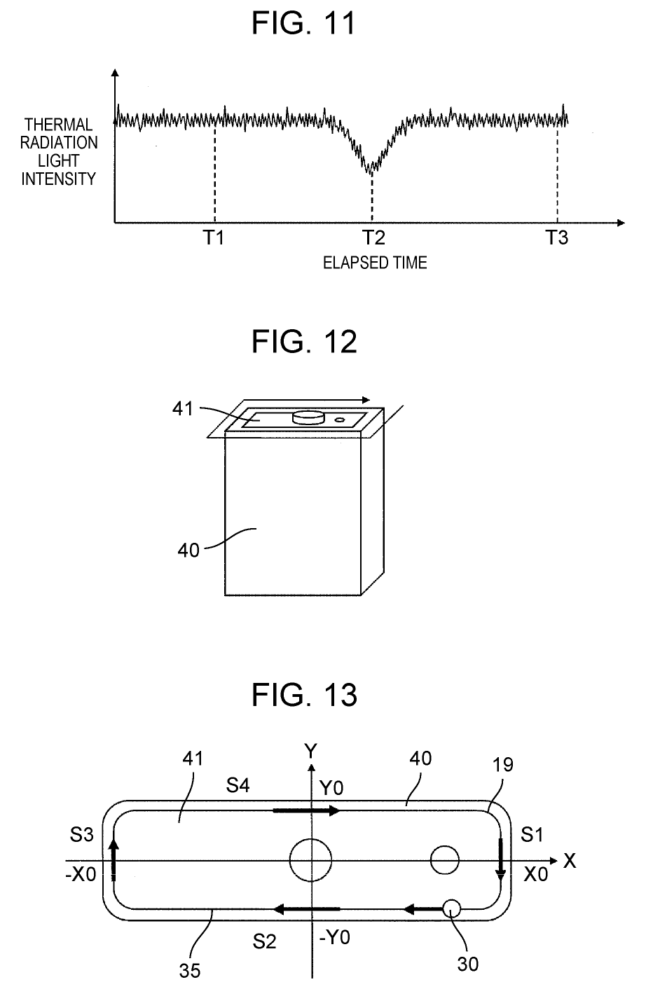

The effect of executing the second mode instead of the first mode when processing is performed by scanning laser beam L1 will be described in more detail with reference to FIGS. 8A to 11. FIGS. 8A to 8C are top views of members 9a, 9b in the line welding processing in the first mode. FIG. 9 is a graph of elapsed time and thermal radiation light intensity measured in FIGS. 8A to 8C. FIGS. 10A to 10C are top views of members 9a, 9b in the line welding processing in the second mode. FIG. 11 is a graph of elapsed time and thermal radiation light intensity measured in FIGS. 10A to 10C.

FIGS. 8A to 8C illustrate states at times T1, T2, and T3 during execution of the first mode, respectively. FIGS. 8A and 8C illustrate normal processing states. In a case where the first mode is executed, the portion of melted portion 31 on the start point 19 side is located outside measurement region 33 in the normal processing state. On the other hand, FIG. 8B illustrates an abnormal processing state in which melted portion 31 is short. Therefore, entire melted portion 31 falls within measurement region 33, and melted portion 31 is not formed outside measurement region 33.

As illustrated in FIG. 9, at time T2 when the abnormal processing state occurs, the thermal radiation light intensity slightly decreases. Since many of the shortened portions of melted portion 31 are outside measurement region 33, it is difficult to distinguish, from signal noise, a decrease in the thermal radiation light intensity due to an abnormal processing state. Therefore, it is difficult to determine whether or not an abnormal processing state has occurred from the temporal change in the thermal radiation light intensity of FIG. 9.

FIGS. 10A to 10C illustrate states at times T1, T2, and T3 during execution of the second mode, respectively. FIGS. 10A and 10C illustrate normal processing states, and FIG. 10B illustrates an abnormal processing state. In a case where the second mode is executed, entire melted portion 31 is located inside measurement region 33 in both the normal processing state and the abnormal processing state.

As illustrated in FIG. 11, since entire melted portion 31 is located inside measurement region 33, the thermal radiation light intensity is higher than the case of FIG. 9 at times T1, T3 when a normal processing state occurs. Therefore, at time T2 when the abnormal processing state occurs, the decrease in the thermal radiation light intensity becomes remarkable. Therefore, when processing is performed by scanning laser beam L1, the second mode is executed, so that it is easy to determine whether or not an abnormal processing state has occurred from the temporal change in the thermal radiation light intensity.

### Operation example: Laser sealing welding

Next, a specific operation example of laser processing apparatus 500 will be described. FIG. 12 is a schematic view of laser sealing welding of a square secondary battery. As illustrated in FIG. 12, in the laser sealing welding, a lid called sealing plate 41 is inserted into exterior case 40 of the square secondary battery, and welding is performed by scanning the outer periphery of sealing plate 41 one round with a laser beam, thereby sealing exterior case 40. The quality of the laser sealing welding greatly affects the product quality of the square secondary battery. Therefore, in the laser sealing welding, in some cases, processing is performed while evaluating a processing state.

FIG. 13 is a top view of exterior case 40 and sealing plate 41. As illustrated in FIG. 13, irradiation spot 30 of laser beam L1 is scanned along a boundary between exterior case 40 and sealing plate 41. Accordingly, scanning path 35 is defined by the boundary between exterior case 40 and sealing plate 41. Scanning path 35 has a substantially rectangular shape including first side S1, second side S2, third side S3, and fourth side S4. For example, irradiation spot 30 is scanned in order of first side S1, second side S2, third side S3, and fourth side S4. In this case, start point 19 of scanning path 35 of irradiation spot 30 is, for example, a corner between first side S1 and fourth side S4. In addition, when the XY axes are taken with the center of sealing plate 41 as a reference (0,0), first side S1 corresponds to X = +X0, second side S2 corresponds to Y = -Y0, third side S3 corresponds to X = -X0, and fourth side S4 corresponds to Y = +Y0.

Since laser beam L1 is scanned, the laser sealing welding is performed in the second mode. In the present operation example, unlike the line welding described above, since scanning path 35 is curved, the direction in which center C2 of measurement region 33 is shifted with respect to irradiation spot 30 in the middle, that is, shift direction L is changed.

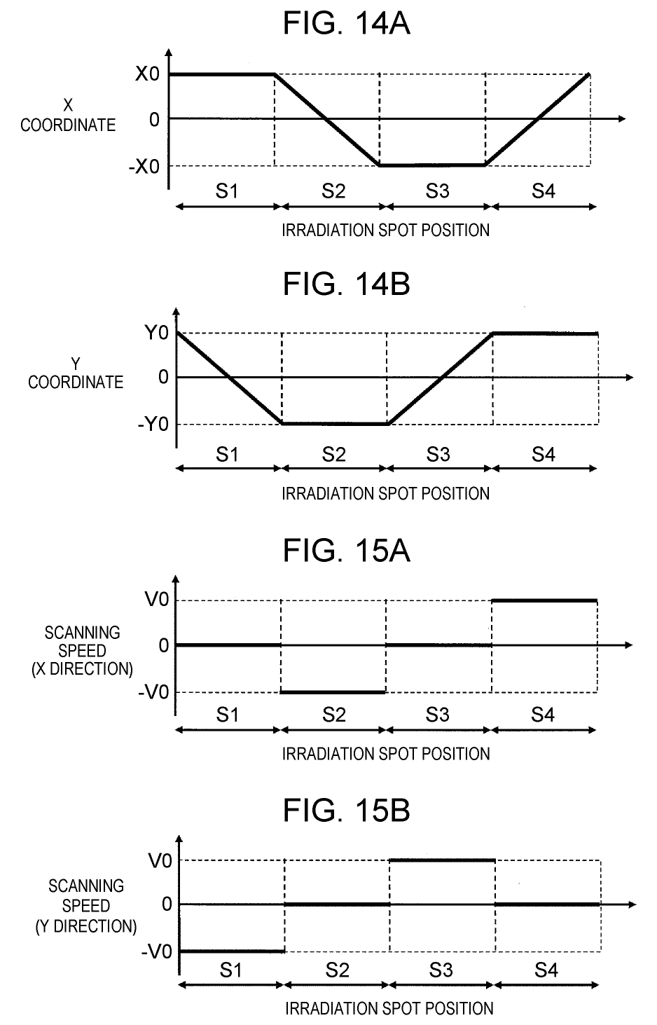

Shift direction L will be described in more detail. First, the movement of irradiation spot 30 will be considered. FIG. 14A is a view illustrating a change in an X coordinate of irradiation spot 30 in scanning path 35. FIG. 14B is a view illustrating a change in the Y coordinate of irradiation spot 30 in scanning path 35. As illustrated in FIGS. 14A and 14B, on first side S1, the X-coordinate of irradiation spot 30 is X0, and the Y-coordinate changes from Y0 to -Y0. On second side S2, the Y-coordinate of irradiation spot 30 is -Y0, and the X-coordinate changes from X0 to -X0. On third side S3, the X-coordinate of irradiation spot 30 is -X0, and the Y-coordinate changes from -Y0 to Y0. On fourth side S4, the Y-coordinate of irradiation spot 30 is Y0, and the X-coordinate changes from -X0 to X0. Here, the meaning of “-” represents a negative direction with respect to the X direction or the Y direction. Note that, in this one-round welding, for example, when movement is performed from first side S1 to second side S2, actually movement is performed in a curved shape, but this part is omitted in the present case.

Irradiation spot 30 moves at a constant speed, and the magnitude of the speed is V0. FIG. 15A is a view illustrating the scanning speed of irradiation spot 30 in the X direction, and FIG. 15B is a view illustrating the scanning speed of irradiation spot 30 in the Y direction. As illustrated in FIGS. 15A and 15B, the scanning speed of irradiation spot 30 is -V0 in the Y direction on first side S1, -V0 in the X direction on second side S2, +V0 in the Y direction on third side S3, and +V0 in the X direction on fourth side S4. Therefore, scanning direction K1 of irradiation spot 30 is the -Y direction on first side S1, the -X direction on second side S2, the +Y direction on third side S3, and the +X direction on fourth side S4.

Control unit 18 determines shift direction L based on scanning direction K1 of irradiation spot 30. Specifically, control unit 18 determines the direction opposite to scanning direction K1 of irradiation spot 30 as shift direction L. Therefore, regardless of scanning direction K1 of irradiation spot 30, center C2 of measurement region 33 is located on the start point 19 side along scanning path 35.

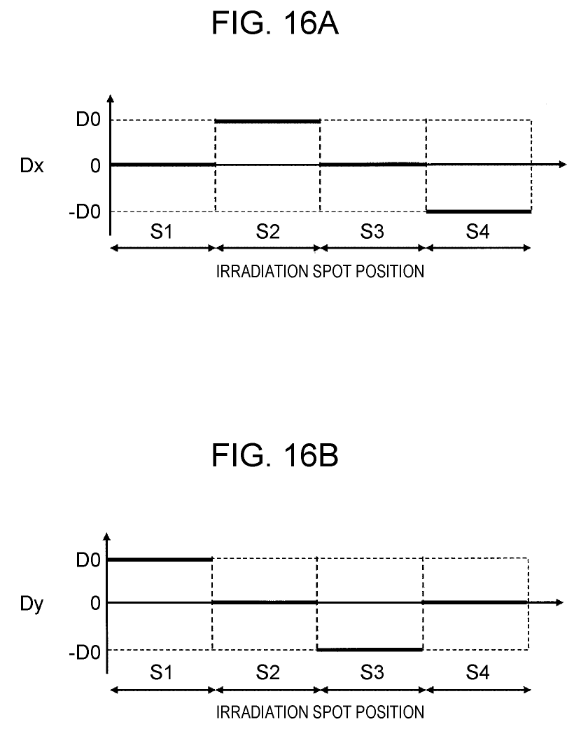

FIG. 16A is a view illustrating shift amount Dx in the X direction, and FIG. 16B is a view illustrating shift amount Dy in the Y direction. As illustrated in FIGS. 16A and 16B, shift amount Dy is +D0 on first side S1, shift amount Dx is +D0 on second side S2, shift amount Dy is -D0 on third side S3, and shift amount Dx is -D0 on fourth side S4. That is, the magnitude of shift amount Dx or shift amount Dy is constant D0, but shift direction L is different. Shift direction L is the +Y direction on first side S1, shift direction L is the +X direction on second side S2, shift direction L is the -Y direction on third side S3, and shift direction L is the -X direction on fourth side S4. As compared with FIGS. 15A and 15B, the reference mark of the scanning speed of irradiation spot 30 is opposite to the reference mark of shift direction L.

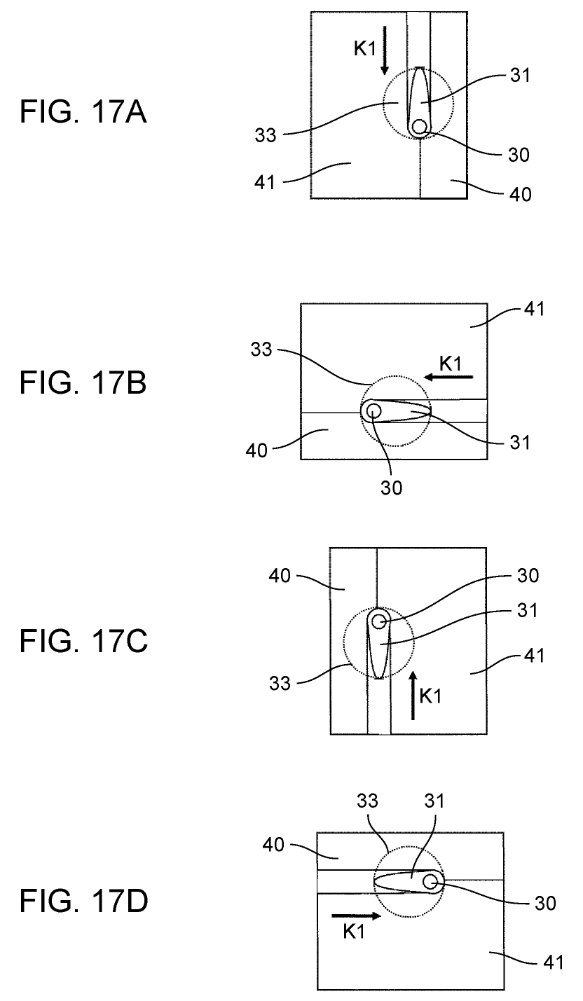

FIGS. 17A to 17D are views illustrating welding states on first side S1 to fourth side S4, respectively. As illustrated in FIGS. 17A to 17D, regardless of scanning direction K1 of irradiation spot 30, the welding light generated from elongated melted portion 31 generated on the rear side of scanning direction K1 of irradiation spot 30 can be measured.

### Operation example: Superposition laser welding

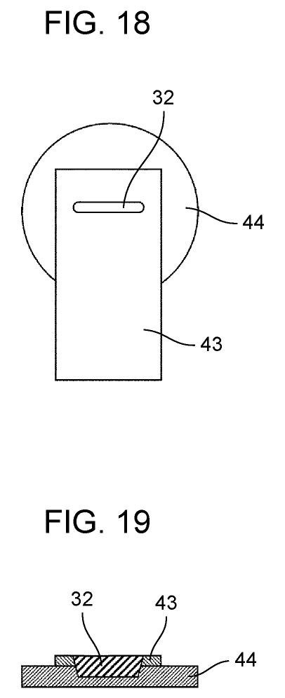

Subsequently, different operation examples of laser processing apparatus 500 will be described. FIG. 18 is a top view of laser welding of an electrode terminal of the cylindrical secondary battery. FIG. 19 is a cross-sectional view of laser welding of the electrode terminal of the cylindrical secondary battery. In the laser welding of the electrode terminal, electrode terminal 43 of the cylindrical secondary battery and electrode plate 44 are overlapped and welded by irradiation with a laser beam from the overlapped direction. As illustrated in FIGS. 18 and 19, electrode terminal 43 and electrode plate 44 are joined with solidified portion 32. The quality of the superposition laser welding greatly affects the product quality of the cylindrical secondary battery. Therefore, in the superposition laser welding, in some cases, processing is performed while evaluating the processing state.

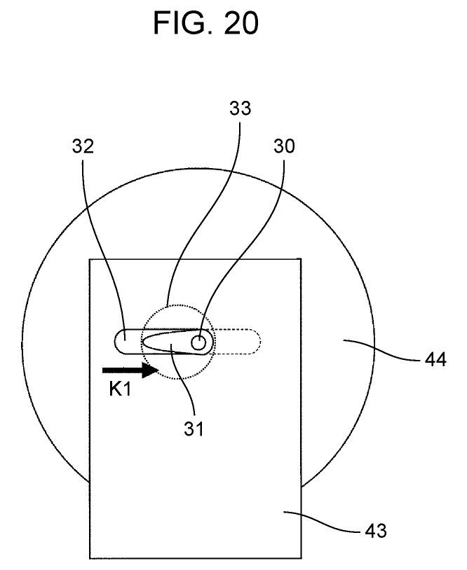

Since laser beam L1 is scanned, the superposition laser welding is performed in the second mode. FIG. 20 is a view illustrating a welding state. As illustrated in FIG. 20, measurement region 33 is shifted in a direction opposite to the scanning direction of irradiation spot 30. Note that, the superposition laser welding in the present case is one line welding of a constant length at a constant speed, and shift amount D and shift direction L of measurement region 33 are constant.

### Effects

Laser processing apparatus 500 according to the first exemplary embodiment can achieve the following effects.

As described above, laser processing apparatus 500 includes oscillator 1, irradiation optical system 102, measurement optical system 103, sensors (light receiving sensors 24a to 24c), moving device 6, adjustment device 12, and control unit 18. Oscillator 1 oscillates laser beam L1. Irradiation optical system 102 guides laser beam L1 to member 9 to be processed. Measurement optical system 103 guides, from measurement region 33, processing light (welding light W1) including any one of thermal radiation light, plasma light, and reflected light emitted from member 9 by irradiation with laser beam L1. Light receiving sensors 24a to 24c measure the intensity of welding light W1 guided by measurement optical system 103. Moving device 6 moves irradiation spot 30 by laser beam L1 relative to member 9 from start point 19 along scanning path 35. Adjustment device 12 shifts the position of measurement region 33 with respect to the position of irradiation spot 30. Control unit 18 controls adjustment device 12 such that center C2 of measurement region 33 is located closer to the start point 19 side than center C1 of irradiation spot 30 along scanning path 35.

With such a configuration, melted portion 31 formed on the start point 19 side of irradiation spot 30 can be included in measurement region 33. Therefore, welding light W1 generated from melted portion 31 formed on the start point 19 side of irradiation spot 30 can be guided to measurement unit 17. Therefore, the evaluation accuracy of the processing state by laser processing apparatus 500 is improved.

In laser processing apparatus 500, moving device 6 moves irradiation spot 30 and measurement region 33 relative to member 9 from start point 19 along scanning path 35.

With such a configuration, by providing common moving device 6 that moves irradiation spot 30 and measurement region 33, measurement region 33 can be moved together with irradiation spot 30. Therefore, it is easy to maintain predetermined shift amount D between measurement region 33 and irradiation spot 30.

In laser processing apparatus 500, moving device 6 includes movable mirrors 6a, 6b that reflect laser beam L1 and welding light W1. Irradiation optical system 102 and measurement optical system 103 have common condenser lens 8 disposed between moving device 6 and member 9.

With such a configuration, after the traveling direction of laser beam L1 and welding light W1 is changed by common moving device 6, laser beam L1 and welding light W1 pass through common condenser lens 8 to reach member 9. Therefore, it is easy to bring measurement region 33 and irradiation spot 30 close to each other and to include irradiation spot 30 in measurement region 33. In other words, it is possible to prevent measurement region 33 and irradiation spot 30 from being excessively separated from each other.

In laser processing apparatus 500, moving device 6 includes movable first mirror 6a and movable second mirror 6b. Adjustment device 12 includes movable third mirror 12a and movable fourth mirror 12b.

With such a configuration, mirrors 6a, 6b are moved, so that irradiation spot 30 and measurement region 33 can be moved in the same manner, that is, in the same scanning speed and scanning direction. Mirrors 12a, 12b are moved, so that measurement region 33 can be offset with respect to irradiation spot 30. In addition, since moving device 6 and adjustment device 12 each have two mirrors, irradiation spot 30 and measurement region 33 can be shifted two-dimensionally.

In laser processing apparatus 500, control unit 18 controls the angle between third mirror 12a and fourth mirror 12b based on the angle between first mirror 6a and second mirror 6b.

With such a configuration, based on the position, the scanning speed, the scanning direction, and the like of irradiation spot 30, measurement region 33 can be offset with respect to irradiation spot 30.

In laser processing apparatus 500, control unit 18 executes control of adjustment device 12 so as to be switchable between the first mode and the second mode. In the first mode, center C2 of measurement region 33 coincides with center C1 of irradiation spot 30. In the second mode, center C2 of measurement region 33 is located closer to the start point 19 side than center C1 of irradiation spot 30.

With such a configuration, even in the processing in which melted portion 31 is formed only around irradiation spot 30, such as spot welding, the processing state can be evaluated with high accuracy. In addition, since irradiation optical system 102 and measurement optical system 103 are partially common, the configuration of laser processing apparatus 500 is simplified.

In laser processing apparatus 500, control unit 18 controls adjustment device 12 based on the scanning speed of irradiation spot 30.

With such a configuration, adjustment device 12 can be controlled such that entire melted portion 31 is included in measurement region 33 even for melted portion 31 having a range or a shape that changes depending on the scanning speed of irradiation spot 30.

In laser processing apparatus 500, based on the scanning speed of irradiation spot 30, control unit 18 determines shift amount D of center C2 of measurement region 33 with respect to center C1 of irradiation spot 30 such that the intensity of welding light W1 measured by light receiving sensors 24a to 24c is maximized.

With such a configuration, more melted portions 31 are included in measurement region 33, and light receiving sensors 24a to 24c can receive more welding light W1. Therefore, the evaluation accuracy of the processing state is further improved.

In laser processing apparatus 500, control unit 18 determines the shift direction of center C2 of measurement region 33 with respect to center C1 of irradiation spot 30 based on scanning direction K1 of irradiation spot 30.

With such a configuration, measurement region 33 can be shifted in the direction opposite to scanning direction K1 of irradiation spot 30. In addition, adjustment device 12 can be controlled such that entire melted portion 31 is included in measurement region 33 even for melted portion 31 whose extending direction changes depending on the scanning direction of irradiation spot 30.

In the first exemplary embodiment, an example in which laser processing apparatus 500 is used for laser welding has been described, but the present invention is not limited thereto. Laser processing apparatus 500 may be used in another processing method of melting a member to be processed by laser irradiation. In this case, welding light W1 in the first exemplary embodiment may be referred to as processing light from the melted portion.

In the first exemplary embodiment, the example in which moving device 6 includes movable mirrors 6a, 6b has been described, but the present invention is not limited thereto. Moving device 6 is only required to be any device that changes the relative positions of irradiation spot 30 and measurement region 33 with respect to member 9. For example, as described later in a first modification, moving device 6 may be a movable stage that supports member 9. Furthermore, moving device 6 may be a head that moves irradiation optical system 102 and measurement optical system 103 with respect to member 9.

In the first exemplary embodiment, an example in which moving device 6 scans both irradiation spot 30 and measurement region 33 has been described, but the present invention is not limited thereto. Measurement region 33 may be scanned by a moving device different from moving device 6. In this case, irradiation optical system 102 and measurement optical system 103 may be configured independently from each other.

In the first exemplary embodiment, an example in which irradiation spot 30 and measurement region 33 are circular has been described, but the present invention is not limited thereto. Irradiation spot 30 and measurement region 33 may have any shape.

In the first exemplary embodiment, an example in which control unit 18 executes the second mode in a case where irradiation spot 30 of laser beam L1 is scanned with respect to member 9 has been described, but the present invention is not limited thereto. For example, in a case where the power of laser beam L1 is small and the scanning speed of irradiation spot 30 is slow, control unit 18 may execute the first mode.

In the first exemplary embodiment, an example has been described in which shift amount D is determined such that the intensity of the measured welding light is maximized in the second mode, but the present disclosure is not limited thereto. For example, in a case where the diameter of measurement region 33 is smaller than the length of melted portion 31, control unit 18 may determine shift amount D such that measurement region 33 just includes the end portion of melted portion 31 on the start point 19 side. With such shift amount D, the end portion of melted portion 31 on the start point 19 side is included in measurement region 33. Therefore, a processing abnormality in which melted portion 31 is shortened is easily detected.

In the first exemplary embodiment, an example in which control unit 18 controls adjustment device 12 based on the operation of moving device 6 (the scanning speed and the scanning direction of irradiation spot 30) has been described, but the present invention is not limited thereto. Control unit 18 may control adjustment device 12 based on other information such as a processing program. In addition, in the case of straight line welding at a constant speed, control unit 18 may apply predetermined shift amount D and shift direction L.

Note that, in the first exemplary embodiment, an example has been described in which irradiation spot 30 moves at a constant scanning speed, but the present invention is not limited thereto. Control unit 18 may change the scanning speed of irradiation spot 30. In this case, control unit 18 may control shift amount D according to a change in the scanning speed.

### Modification 1

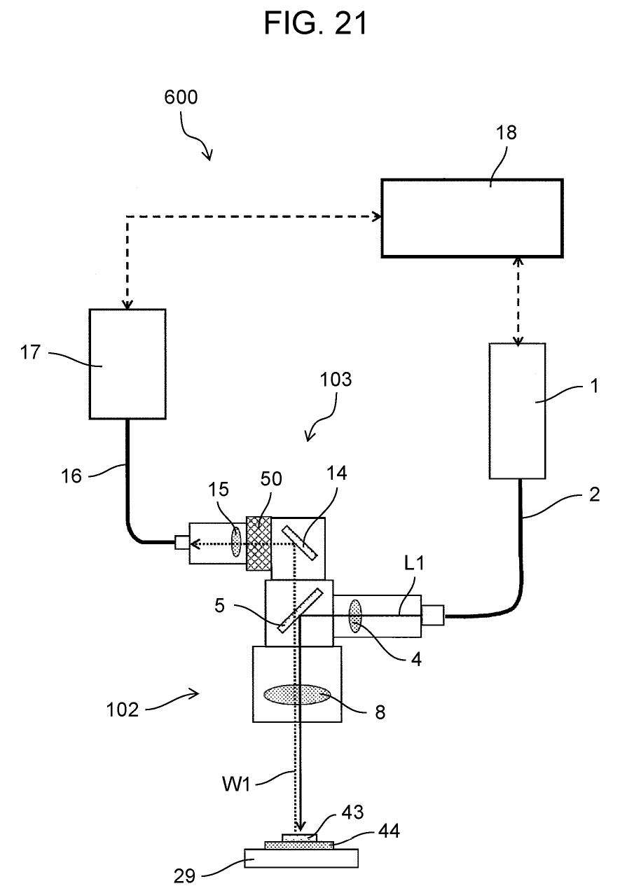

FIG. 21 is an overall view of laser processing apparatus 600 in a first modification. As illustrated in FIG. 21, laser processing apparatus 600 includes stage 29 instead of moving device 6, and includes adjustment mechanism 50 instead of adjustment device 12. Unless otherwise specified, the structure of laser processing apparatus 600 may be similar to that of laser processing apparatus 500 according to the first exemplary embodiment.

Stage 29 is a movable stage. Stage 29 may move in one direction or may move multidimensionally. The movement of stage 29 is controlled by control unit 18.

Adjustment mechanism 50 is provided in imaging lens 15, and can shift the imaging position of imaging lens 15 in a direction intersecting the optical axis of imaging lens 15. For example, adjustment mechanism 50 may be a mechanism that moves imaging lens 15 with respect to the optical axis of measurement optical system 103. The position of measurement region 33 can be changed by adjustment of the imaging position in the direction intersecting the optical axis. In a case where the scanning speed of irradiation spot 30 is constant, the position of measurement region 33 is also adjusted once by adjustment mechanism 50, so that it is possible to omit time and effort to adjust adjustment mechanism 50 that monitors and adjusts the operation of stage 29 as needed. Adjustment mechanism 50 is controlled by control unit 18. Control unit 18 may operate adjustment mechanism 50 by predetermined adjustment amount to adjust the imaging position of imaging lens 15.

Here, the operation of laser processing apparatus 600 will be described in an example in which electrode terminal 43 and electrode plate 44 are overlapped and welded. Electrode plate 44 is disposed on stage 29, and electrode terminal 43 is disposed thereon. Control unit 18 irradiates electrode terminal 43 with laser beam L1. When stage 29 moves linearly, electrode terminal 43 and electrode plate 44 are welded in a line shape. Control unit 18 adjusts the imaging position of imaging lens 15 by adjustment mechanism 50, and shifts measurement region 33 with respect to irradiation spot 30.

A laser processing apparatus according to a first aspect includes: an oscillator that oscillates a laser beam; an irradiation optical system that guides the laser beam to a member to be processed; a measurement optical system that guides, from a measurement region, processing light including any one of thermal radiation light, plasma light, and reflected light emitted from the member by irradiation with the laser beam; a sensor that measures intensity of the processing light guided by the measurement optical system; a moving device that moves an irradiation spot by the laser beam relative to the member from a start point along a scanning path; an adjustment device that shifts a position of the measurement region with respect to a position of the irradiation spot; and a control unit that controls the adjustment device such that a center of the measurement region is located closer to a start point side than a center of the irradiation spot along the scanning path.

As the laser processing apparatus according to a second aspect, in the laser processing apparatus according to the first aspect, the moving device moves the irradiation spot and the measurement region relative to the member from the start point along the scanning path.

As the laser processing apparatus according to a third aspect, in the laser processing apparatus according to the second aspect, the moving device includes a movable mirror that reflects the laser beam and the processing light, and the irradiation optical system and the measurement optical system have a common condenser lens disposed between the moving device and the member.

As the laser processing apparatus according to a fourth aspect, in the laser processing apparatus according to the third aspect, the moving device includes a movable first mirror and a movable second mirror, and the adjustment device includes a movable third mirror and a movable fourth mirror.

As the laser processing apparatus according to a fifth aspect, in the laser processing apparatus according to the fourth aspect, the control unit controls an angle between the third mirror and the fourth mirror based on an angle between the first mirror and the second mirror.

As the laser processing apparatus according to a sixth aspect, in the laser processing apparatus according to any one of the first to fifth aspects, the control unit executes control of the adjustment device to be switchable between a first mode in which the center of the measurement region coincides with the center of the irradiation spot and a second mode in which the center of the measurement region is located closer to the start point side than the center of the irradiation spot.

As the laser processing apparatus according to a seventh aspect, in the laser processing apparatus according to any one of the first to sixth aspects, the control unit controls the adjustment device based on a scanning speed of the irradiation spot.

As the laser processing apparatus according to an eighth aspect, in the laser processing apparatus according to the seventh aspect, the control unit determines a shift amount of the center of the measurement region with respect to the center of the irradiation spot based on a scanning speed of the irradiation spot such that intensity of the processing light measured by the sensor is maximized.

As the laser processing apparatus according to a ninth aspect, in the laser processing apparatus according to any one of the first to the eighth aspects, the control unit determines a shift direction of the center of the measurement region with respect to the center of the irradiation spot based on a scanning direction of the irradiation spot.

Although the present disclosure has been fully described with reference to a preferred exemplary embodiment and with reference to the accompanying drawings, various variations and modifications will become apparent to those skilled in the art. It should be understood that, as long as such variations and modifications do not deviate from the scope of the present invention according to claims appended, such variations and modifications are included therein.

### INDUSTRIAL APPLICABILITY

The laser processing apparatus of the present disclosure is particularly useful in a laser processing apparatus that performs processing such as laser welding while monitoring a processing state in real time.

### REFERENCE MARKS IN THE DRAWINGS

1: oscillator

6: moving device

6a: mirror

6b: mirror

7: first mirror control unit

9: member

12: adjustment device

12a: mirror

12b: mirror

13: second mirror control unit

17: measurement unit

30: irradiation spot

31: melted portion

33: measurement region

102: irradiation optical system

103: measurement optical system

500: laser processing apparatus

W1: welding light

D: shift amount

1. A laser processing apparatus comprising:
an oscillator that oscillates a laser beam;
an irradiation optical system that guides the laser beam to a member to be processed;
a measurement optical system that guides, from a measurement region, processing light including any one of thermal radiation light, plasma light, and reflected light emitted from the member by irradiation with the laser beam;
a sensor that measures intensity of the processing light guided by the measurement optical system;
a moving device that moves an irradiation spot by the laser beam relative to the member from a start point along a scanning path;
an adjustment device that shifts a position of the measurement region with respect to a position of the irradiation spot; and
a control unit that controls the adjustment device to position a center of the measurement region closer to a start point side than a center of the irradiation spot along the scanning path.

2. The laser processing apparatus according to claim 1, wherein the moving device moves the irradiation spot and the measurement region relative to the member from the start point along the scanning path.

3. The laser processing apparatus according to claim 2, wherein the moving device includes a movable mirror that reflects the laser beam and the processing light, and
the irradiation optical system and the measurement optical system have a common condenser lens disposed between the moving device and the member.

4. The laser processing apparatus according to claim 3, wherein the moving device includes a movable first mirror and a movable second mirror, and the adjustment device includes a movable third mirror and a movable fourth mirror.

5. The laser processing apparatus according to claim 4, wherein the control unit controls an angle between the third mirror and the fourth mirror based on an angle between the first mirror and the second mirror.

6. The laser processing apparatus according to claim 1, wherein the control unit executes control of the adjustment device to be switchable between a first mode in which the center of the measurement region coincides with the center of the irradiation spot and a second mode in which the center of the measurement region is located closer to the start point side than the center of the irradiation spot.

7. The laser processing apparatus according to claim 1, wherein the control unit controls the adjustment device based on a scanning speed of the irradiation spot.

8. The laser processing apparatus according to claim 7, wherein the control unit determines a shift amount of the center of the measurement region with respect to the center of the irradiation spot based on a scanning speed of the irradiation spot to maximize intensity of the processing light measured by the sensor.

9. The laser processing apparatus according to claim 1, wherein the control unit determines a shift direction of the center of the measurement region with respect to the center of the irradiation spot based on a scanning direction of the irradiation spot.
